(19) United States
(12) Patent Application Publication
(10) Pub. No.: US 2016/0209128 A1
(43) Pub. Date: Jul. 21, 2016

(54) COMPOSITE PASSIVE HEAT SINK SYSTEM AND METHOD

(71) Applicant: Hamilton Sundstrand Space Systems International, Inc., Windsor Locks, CT (US)

(72) Inventor: Jesse Joseph Stieber, Avon, CT (US)

(73) Assignee: Hamilton Sundstrand Space Systems International, Inc., Windsor Locks, CT (US)

(21) Appl. No.: 14/597,703

(22) Filed: Jan. 15, 2015

(51) Int. Cl. F28F 3/00; B23P 15/26

(52) U.S. Cl. CPC F28F 3/00; B23P 15/26

(57) ABSTRACT

A system including a passive heat sink is depicted. A passive heat sink may include an enclosure housing a nonmetal matrix composite. At least one surface of the enclosure may be in contact and/or close proximity to a heat source. The enclosure may be formed through an additive manufacturing process.

### FIELD

The present disclosure relates heat sinks, and more particularly, to systems and methods of increasing the efficiency of heat sinks

### BACKGROUND

A heat sink may be configured to transfer thermal energy from a higher temperature component to a lower temperature medium, such as a fluid medium. If the fluid medium is water, the heat sink may be referred to as a cold plate. In thermodynamics, a heat sink is a heat reservoir configured to absorb heat without significantly changing temperature. Heat sinks for electronic devices often have a temperature higher than the surroundings to transfer heat by convection, radiation, and/or conduction.

To understand the principle of a heat sink, consider Fourier's law of heat conduction. Fourier's law states that the rate of heat flow, dQ/dt, through a homogeneous solid is directly proportional to the area, A, of the section at right angles to the direction of heat flow, and to the temperature difference along the path of heat flow, dT/dx. (The proportionality ratio, X, is the thermal conductivity of the material). Resulting in: dQ/dt=−λ A dT/dx.

### SUMMARY

The present disclosure relates to a passive heat sink system. According to various embodiments, the passive heat sink system may include an enclosure defining an internal cavity. The passive heat sink system may include a conductive matrix disposed within the internal cavity. The passive heat sink system may include a phase change material at least partially collocated with the conductive matrix within the internal cavity. The enclosure is at least partially formed around the conductive matrix via an additive manufacturing process. The passive heat sink system may include a port configured to pass through an external surface of the enclosure to the internal cavity. The phase change material may be added to the internal cavity via the port.

The passive heat sink system may include a heat sink surface disposed on an external surface of the enclosure. A wetted coupling may be formed between an interface between the conductive matrix and a surface of the enclosure in response to the additive manufacturing process occurring. The additive manufacturing process comprises successive layers of material being laid down under computer control to form a component. The additive manufacturing process comprises at least one of direct metal laser sintering, selective laser melting, or selective laser sintering. The flow of heat from a heat sink surface to the conductive matrix is direct through the enclosure to the conductive matrix. Stated another way, the coupling of the enclosure to the conductive matrix is free of intervening adhesives and/or bonding agents. The conductive matrix comprises a graphite matrix.

According to various embodiments, a method of forming a passive heat sink is described herein. The method may include forming a first portion of a heat sink assembly enclosure. The method may include positioning a conductive matrix within an internal cavity of the first portion of the heat sink assembly enclosure. The method may include forming a second portion of the heat sink assembly enclosure, wherein at least one of the first portion of the heat sink assembly enclosure or the second portion of the heat sink assembly enclosure is formed via an additive manufacturing process.

The heat sink assembly enclosure may include a port configured to pass through at least one of the first portion of the heat sink assembly enclosure or the second portion of the heat sink assembly enclosure to the internal cavity. A phase change material may be added to the internal cavity via the port. A heat sink surface may be disposed on an external surface of at least one of the first portion of the heat sink assembly enclosure or the second portion of the heat sink assembly enclosure. A wetted coupling may be formed between an interface between the conductive matrix and a surface of at least one of the first portion of the heat sink assembly enclosure or the second portion of the heat sink assembly enclosure in response to the additive manufacturing process occurring.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 depicts a representative heat sink device in accordance with various embodiments;

FIG. 2 depicts a representative composite passive heat sink, in accordance with various embodiments;

FIG. 3 depicts the cross-sectional view of the heat sink of FIG. 2, in accordance with various embodiments; and

FIG. 4 depicts a method for creating a composite passive heat sink assembly in accordance with various embodiments.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the disclosure, it should be understood that other embodiments may be realized and that logical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step.

The present disclosure relates to a heat sink, and more particularly a heat sink with desirable thermally conductive joints. Conventionally, phase change material (PCM) heat sinks use water, wax, fluid, or other materials with desirable melting points to store and release the heat energy associated with the solid liquid phase change, called the latent heat of fusion. A traditional heat sink is made from a common material (i.e. aluminum or stainless steel), the joining of the different parts, fin or metal matrix to a thermal interface sheet is commonly done through a traditional braze process. This creates a structural and thermally conductive joint. These types of homogenous PCM heat sinks have a low PCM to structure mass ratio. To increase the PCM to structure mass ratio a highly conductive light weight matrix material may be utilized, the highly conductive light weight matrix materials are typically nonmetal materials. Conventionally, when joining the nonmetal matrix to a metal thermal interface sheet, a bond or glue is applied between the nonmetal matrix and the thermal interface, (e.g., heat sink surface). This creates a weak structural joint and a less than desirable thermally conductive joint. The glue adds a thermal resistance to the heat transfer path which is not present in a typical all metal joint.

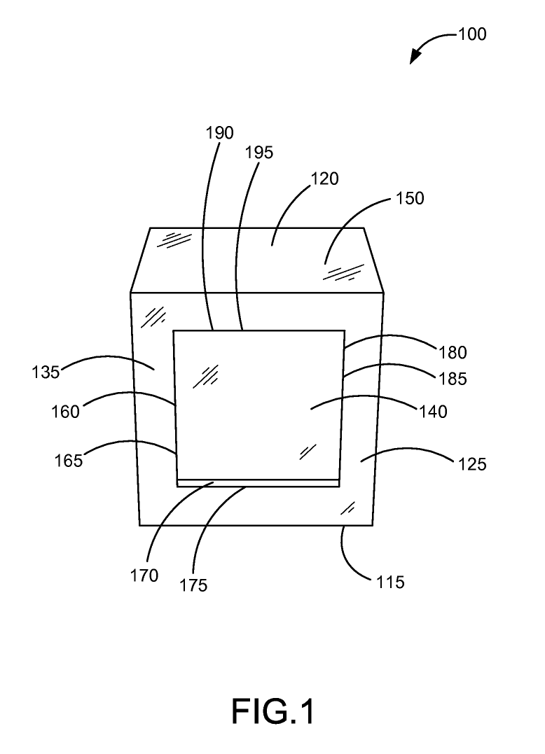

According to various embodiments and with reference to FIG. 1 a passive heat sink is depicted. An enclosure 150 housing a nonmetal matrix composite component 140 is depicted. At least one surface, such as top surface 120, of the enclosure 150 may be in contact and/or close proximity to a heat source. The nonmetal matrix composite component 140 may comprise any nonmetal matrix composite materials, for instance the nonmetal matrix composite may be a graphite matrix, such as Poco Foam®. Adhering the nonmetal matrix composite component 140 to the enclosure with adhesive may result in poor thermal conductivity through the adhesive. The systems and methods described herein may mitigate these thermal conductivity concerns.

According to various embodiments, an assembly 100 may be formed. The assembly 100 may comprise an enclosure 150. The enclosure 150 may be formed through any desired process. The enclosure 150 may be formed through an additive manufacturing process. Specifically, the enclosure 150 may be formed through an additive manufacturing process while the partially formed enclosure is in contact with a nonmetal matrix composite component 140. Additive manufacturing is the use of one of various processes to make a three-dimensional component.

Additive manufacturing may comprise successive layers of material being laid down under computer control to form a component. These objects can be of almost any shape or geometry, and are produced from a three dimensional model or other electronic data source.

Additive manufacturing processes include direct metal laser sintering (DMLS). DMLS is an additive manufacturing technique that uses a laser as a power source to sinter powdered material (typically metal), aiming the laser automatically at points in space defined by a 3D model, binding material together to create a solid structure. Additive manufacturing processes include selective laser melting. Selective laser melting is a process that uses 3D data, such as 3D CAD data, as a digital information source and energy in the form of a high-power laser beam (such as a ytterbium fiber laser) to create a three-dimensional metal component by fusing metallic powders together. Additive manufacturing processes include selective laser sintering (SLS) SLS is a technique that uses a laser as a power source to sinter powdered material (typically metal), aiming the laser automatically at points in space defined by a 3D model, binding the material together to create a solid structure. It is similar to DMLS.

The enclosure 150 may comprise at least one of a base 115, first side wall 135, second side wall 125 and top surface 120. Any surface, such as an external surface, of the enclosure 150 may comprise a heat sink surface. According to various embodiments, enclosure 150 may be partially formed. For instance, least one of a base 115, first side wall 135, second side wall 125 and top surface 120 may be formed, such as through an additive manufacturing process. A nonmetal matrix composite component 140 may be inserted within the partially formed enclosure 150. An integral bond may be formed between the exterior walls of the nonmetal matrix composite component 140 and the interior walls of the enclosure 150. For instance, the nonmetal matrix composite component 140 may comprise a first side wall 160, a second side wall 180, a top surface 190 and a bottom surface 170. The enclosure 150 may comprise an interior first side wall 165, a second interior side wall 185, an interior top surface 195, and an interior base surface 175. The interior shape and size of the enclosure 150 may be sized to approximately mirror the exterior shape and size of the nonmetal matrix composite component 140. Wetted bonds may be formed between at least one of the first side wall 160 and the interior first side wall 165; the second side wall 180 and the second interior side wall 185; the top surface 190 and the interior top surface 195; or the bottom surface 170 and an interior base surface 175. Wetting is the ability of a liquid to maintain contact with a solid surface, resulting from intermolecular interactions when the two are brought together. The degree of wetting (wettability) is determined by a force balance between the adhesive and cohesive forces present. In this way, the high heat conditions of the additive manufacturing process forming the enclosure 150 around the nonmetal matrix composite component 140 may cause a wetted condition to occur.

According to various embodiments, the high heat conditions of the additive manufacturing process forming the enclosure 150 around the nonmetal matrix composite component 140 and/or inserting the nonmetal matrix composite component 140 in a partially formed and still hot enclosure 150 cause a bond between adjacent dissimilar material surfaces to occur.

According to various embodiments, in this way the conduction path is efficient as no foreign bonding agents are present. Stated another way, a glueless, bondless, coupling between the enclosure 150 and the nonmetal matrix composite component 140 creates an efficient conduction path, such as for a heat sink. By forming the enclosure 150 around the nonmetal matrix composite component 140, concerns of differences in thermal expansion between the enclosure 150 and the nonmetal matrix composite component 140 are mitigated. The flow of heat from a top surface 120 (e.g., heat sink surface) to the matrix composite component 140 is direct through the enclosure 150 to the matrix composite component 140. Stated another way, the coupling of the enclosure 150 to the matrix composite component 140 is free of intervening adhesives and/or bonding agents.

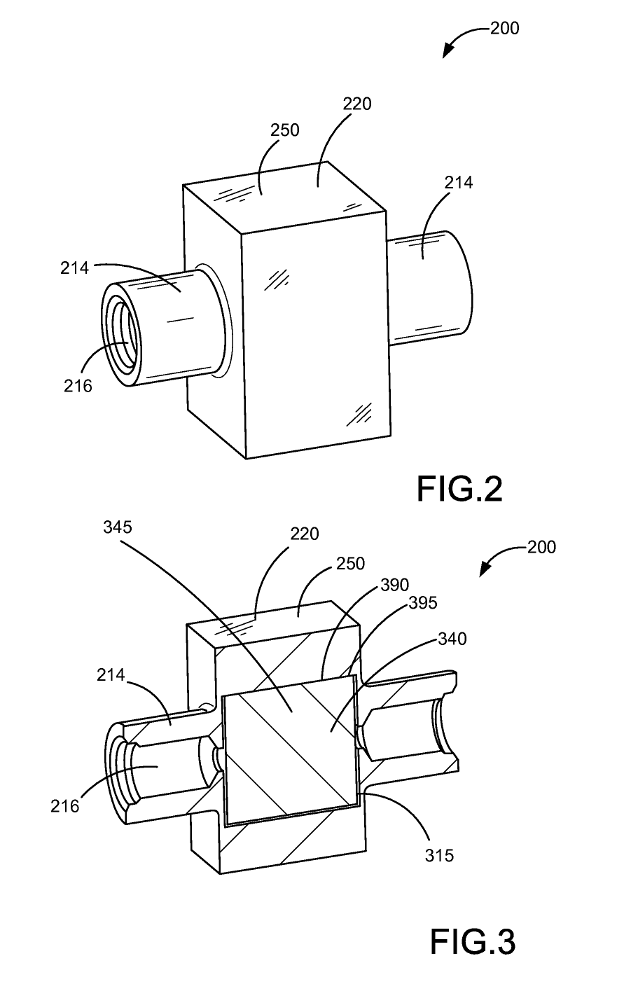

According to various embodiments, and with reference to FIGS. 2 and 3, a passive heat sink assembly 200 is depicted. Passive heat sink assembly 200 comprises an enclosure 250 which defines an internal cavity 315. A conductive matrix 340 may substantially fill the internal cavity 315. As described above with reference to assembly 100, enclosure 250 may be additively manufactured around the conductive matrix 340. The conductive matrix 340 may be made from any desired material; however, in various embodiments, the conductive matrix is a porous graphite matrix. The internal cavity may further comprise a phase change material (PCM) 345, such as wax. PCM 345 may be added to the internal cavity 315 at any time; however, according to various embodiments, PCM 345 is added to internal cavity 315 via port 216 of tube 214. Port 216 may be configured to pass through an external surface of the enclosure 250 to the internal cavity 315. Tube 214 may be closed in response to a desired volume of PCM 345 around conductive matrix 340 within internal cavity 315 being reached. The top surface 220 of enclosure 250 may be a heat sink surface. In this way, thermal energy may be transferred through top surface 220, across the efficient conductive interface between the interior top surface 395 of enclosure 250 to the top surface 390 of conductive matrix 340. The PCM 345 may store the energy by undergoing a phase change.

As described herein an additive manufacturing process is utilized to encapsulate a nonmetal matrix, such as conductive matrix 340 and create structural and thermally conductive joint at the thermal interface between conductive matrix 340 and its enclosure, such as enclosure 250. This is achieved via the metal of enclosure 250 wetting to the conductive matrix 340 which creates the passive heat sink assembly 200. Due it its lack of thermally resistive bonds at the metal to high conductivity matrix interface, passive heat sink assembly 200 has improved the heat transfer characteristics as compared with conventional heat sinks The structural capacity of the passive heat sink assembly 200 is limited by the strength of the matrix not its bond joints.

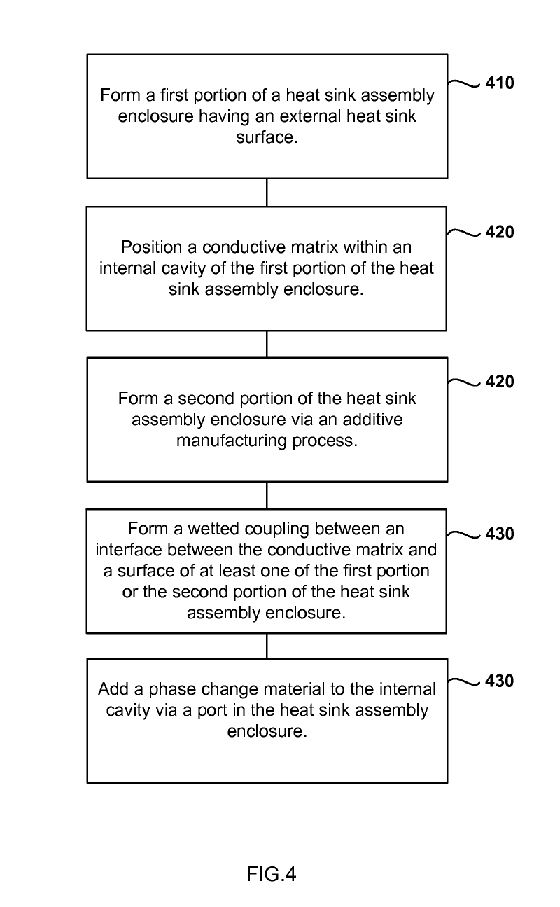

According to various embodiments, and with reference to FIG. 4, a method for creating a passive heat sink assembly 200, such as a composite passive heat sink assembly is described. The method may include, forming a first portion of a heat sink assembly enclosure having an external heat sink surface (Step 410). The first portion may comprise at least one of a base or one or more side walls. A conductive matrix may be positioned within an internal cavity of the first portion of the heat sink assembly enclosure (Step 420). This positioning may by any suitable process. For instance, the conductive matrix may be formed within the first portion of the heat sink assembly enclosure, such as by an additive manufacturing process, substantially in concert with the formation of at least one of first portion of the heat sink assembly enclosure or the second portion of the heat sink assembly enclosure. A second portion of the heat sink assembly enclosure may be formed via an additive manufacturing process. (Step 420) A wetted coupling may be made between an interface between the conductive matrix and a surface of at least one of the first portion or the second portion of the heat sink assembly enclosure (Step 430). A phase change material may be added to the internal cavity via a port formed in the heat sink assembly enclosure (Step 430).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Different cross-hatching is used throughout the figures to denote different parts but not necessarily to denote the same or different materials.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A passive heat sink system comprising:
an enclosure defining an internal cavity;
a conductive matrix disposed within the internal cavity, wherein the enclosure is at least partially formed around the conductive matrix via an additive manufacturing process; and
a phase change material at least partially collocated with the conductive matrix within the internal cavity.

2. The passive heat sink system of claim 1, further comprising a port configured to pass through an external surface of the enclosure to the internal cavity.

3. The passive heat sink system of claim 2, wherein the phase change material is added to the internal cavity via the port.

4. The passive heat sink system of claim 1, further comprising a heat sink surface disposed on an external surface of the enclosure.

5. The passive heat sink system of claim 1, wherein a wetted coupling is formed between an interface between the conductive matrix and a surface of the enclosure in response to the additive manufacturing process occurring.

6. The passive heat sink system of claim 1, wherein the additive manufacturing process comprises successive layers of material laid down under computer control to form a component.

7. The passive heat sink system of claim 1, wherein the additive manufacturing process comprises at least one of direct metal laser sintering, selective laser melting, or selective laser sintering.

8. The passive heat sink system of claim 1, wherein a flow of heat from a heat sink surface to the conductive matrix is direct through the enclosure to the conductive matrix.

9. The passive heat sink system of claim 1, wherein the conductive matrix comprises a graphite matrix.

10. A method comprising:
forming a first portion of a heat sink assembly enclosure;
positioning a conductive matrix within an internal cavity of the first portion of the heat sink assembly enclosure; and
forming a second portion of the heat sink assembly enclosure, wherein at least one of the first portion of the heat sink assembly enclosure or the second portion of the heat sink assembly enclosure is formed via an additive manufacturing process.

11. The method of claim 10, further comprising forming a port configured to pass through at least one of the first portion of the heat sink assembly enclosure or the second portion of the heat sink assembly enclosure to the internal cavity.

12. The method of claim 11, further comprising adding a phase change material to the internal cavity via the port.

13. The method of claim 10, wherein a heat sink surface is disposed on an external surface of at least one of the first portion of the heat sink assembly enclosure or the second portion of the heat sink assembly enclosure.

14. The method of claim 10, further comprising forming a wetted coupling between an interface between the conductive matrix and a surface of at least one of the first portion of the heat sink assembly enclosure or the second portion of the heat sink assembly enclosure in response to the additive manufacturing process occurring.

15. The method of claim 10, wherein the additive manufacturing process comprises at least one of direct metal laser sintering, selective laser melting, or selective laser sintering.
